(19) United States
(12) Patent Application Publication
(10) Pub. No.: US 2006/0114567 A1
(43) Pub. Date: Jun. 1, 2006

(54) Optical film for backlight unit and method for manufacturing the same

(75) Inventors: Yong-Shig Shim, Seoul (KR); Sung-Min Cho, Gyeonggi-do (KR); Young-Il Kim, Gyeonggi-do (KR); Eun-Mi Lee, Gyeonggi-do (KR)

Correspondence Address: JENKENS & GILCHRIST, P.C., 901 15TH STREET N.W., SUITE 900, WASHINGTON, DC, 20005, US

(73) Assignees: LGS Corporation Ltd., Gyeonggi-do (KR); Woo Joo LAH, Gyeonggi-do (KR)

(21) Appl. No.: 11/325,554

(22) Filed: Jan. 5, 2006

(30) Foreign Application Priority Data
Nov. 10, 2003 (WO) PCT/KR03/02406
Jul. 10, 2003 (KR) 10-2003-0046708

(51) Int. Cl. G02B 1/10

(52) U.S. Cl. 359/586

(57) ABSTRACT

The present invention relates to an optical film for a backlight unit and a method for manufacturing the same. The optical film of the present invention comprises a light diffusion layer in which light diffusing particles are distributed, a first refraction layer which has a relatively low index of refraction and is formed integrally on a top surface of the light diffusion layer, and a second refraction layer which has an index of refraction relatively higher than that of the first refraction layer and is formed integrally on a top surface of the first refraction layer and formed with a refraction pattern on a surface thereof. According to the present invention, the loss of light can be prevented, the adsorption of foreign substances in and the resultant scratch generation on the films can be avoided during the assembly process of the backlight unit, the productivity improvement and manufacturing cost reduction can be achieved, and the brightness of the backlight unit can be adjusted.

### TECHNICAL FIELD

The present invention relates to an optical film for a backlight unit and a method for manufacturing the same.

### BACKGROUND ART

As shown in FIG. 8, a backlight unit 101 for use in a general display device is provided with a lamp 125, a light guide plate 120 and a reflection film 150 at a lower portion in a support frame 105, and also configured in such a manner that a diffusion film 110, a pair of prism films 115 and a protection film 130 are sequentially disposed on the light guide plate 120.

In such a backlight unit 101 for use in the display device, light emitted from the lamp 125 travels along surfaces of the light guide plate 120 and is reflected and scattered to move to the diffusion film 110 which is placed above the light guide plate 120. After the light is scattered and diffused by light diffusing particles 111 distributed in the diffusion film 110, it is collected or condensed and refracted in a direction perpendicular to the surface of the light guide plate by a refraction pattern formed on each surface of the prism films 115. The light, which has been collected and refracted in each of the prism films 115, passes through the protection film 130 and then enters into a panel 140 to display an image on the panel 140.

However, in such a related art backlight unit, there is a problem in that a brightness of light is reduced due to a loss of a portion of light between the diffusion film and the pair of prism films because the films are used to diffuse and collect the light transmitted from the light guide plate.

Further, there is another problem in that the adsorption of foreign substance in and scratches due to the contact of foreign substances with the films are highly likely to occur during the subsequent assembly process of the respective diffusion and prism films.

Furthermore, there is still another problem in that the decrease of productivity due to the increase of assembly process and the increase of manufacturing Cost due to the increase of the number of films can be brought about, because the processes of assembling the diffusion and prism films are separately carried out when assembling the backlight unit.

In addition, to ensure a desired brightness, a pair of stacked prism films with the same constant index of refraction are used in the related art backlight unit. Therefore, there is a still further problem in that it causes the addition of a process of stacking the prism films one above another, the productivity decrease and manufacturing cost increase, and it is substantially difficult to ensure a desired brightness due to inherent difficulty in the adjustment of brightness.

### DISCLOSURE OF THE INVENTION

The present invention is conceived to solve the aforementioned problems. An object of the present invention is to provide an optical film for a backlight unit capable of reducing a loss of light, preventing the adsorption of foreign substances and the scratch generation during its assembly process, achieving productivity improvement and manufacturing cost reduction, and adjusting the brightness thereof, and a method for manufacturing the optical film for the backlight unit.

According to an aspect of the present invention for achieving the object, there is provided an- optical film for a backlight unit which comprises a light diffusion layer in which light diffusing particles are distributed, a first refraction layer which has a relatively low index of refraction and is formed integrally on a top surface of the light diffusion layer, and a second refraction layer which has an index of refraction relatively higher than that of the first refraction layer and is formed integrally on a top surface of the first refraction layer and formed with a refraction pattern on a surface thereof.

Preferably, the light diffusion layer is made of a transparent polyester resin and the first and second refraction layers are made of a transparent acrylic resin.

At this time, a difference between the indexes of refraction of the first and second refraction layers is determined by a difference between composition ratios of the transparent acrylic resins.

Further, it is preferred that the light diffusing particles be either transparent particles made of a material selected from the group consisting of acryl, styrene, silicone, synthetic silica, glass beads and diamond, or white particles made of at least one material selected from the group consisting of titanium oxide, zinc oxide, barium sulfate, calcium carbonate, magnesium carbonate, aluminum hydroxide and clay.

Furthermore, the refraction pattern may have a shape selected from the group consisting of a triangular cross section, a circular arc cross section, a polygonal cone, a circular cone or a hemisphere.

According to another aspect of the present invention for achieving the above object, there is provided a method for manufacturing an optical film for a backlight unit, comprising the steps of forming a light diffusion layer with light diffusing particles distributed therein, forming a first refraction layer with a relatively low index of refraction on a top surface of the light diffusion layer, forming a second refraction layer with a relatively higher index of refraction on a top surface of the first refraction layer, and forming a refraction patter on a surface of the second refraction layer.

Preferably, the light diffusing particles are made of a transparent polyester resin, and the first and second refraction layers are formed by coating a liquid transparent acrylic resin on the top surface of the light diffusion layer.

At this time, a difference between the indexes of refraction of the first and second refraction layers is determined by a difference between composition ratios of the transparent acrylic resins.

Further, it is preferred that the light diffusing particles be either transparent particles made of a material selected from the group consisting of acryl, styrene, silicone, synthetic silica, glass beads and diamond, or white particles made of at least one material selected from the group consisting of titanium oxide, zinc oxide, barium sulfate, calcium carbonate, magnesium carbonate, aluminum hydroxide and clay.

Furthermore, it is preferred that the step of forming the refraction pattern comprise the step of forming, on the surface of the second refraction layer, a shape selected from the group consisting of a triangular cross section, a circular arc cross section, a polygonal cone, a circular cone or a hemisphere.

### BRIEF DESCRIPTION OF THE DRAWINGS

FIG. 1 is a sectional view of an optical film for a backlight unit according to the present invention.

FIG. 2 is a block diagram illustrating the processes of manufacturing the optical film for the backlight unit according to the present invention.

FIG. 3 is a schematic sectional view of the backlight unit with the optical film of FIG. 1 installed therein.

FIGS. 4 to 7 are perspective views of an optical film for a backlight unit according to other embodiments of the present invention.

FIG. 8 is a sectional view of a backlight unit with a related art optical film installed therein.

### BEST MODE FOR CARRYING OUT THE INVENTION

Hereinafter, the present invention will be explained in detail with reference to the accompanying drawings.

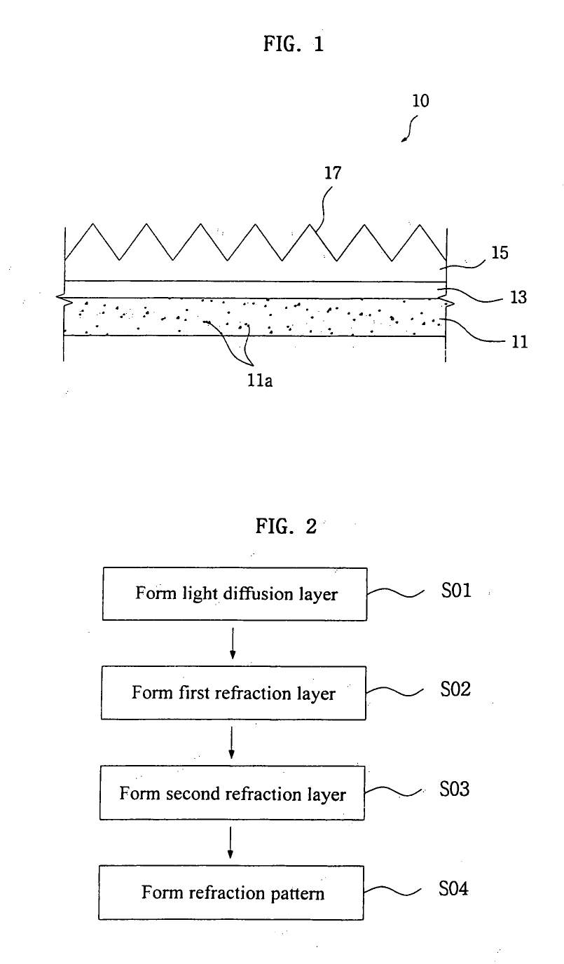

FIG. 1 is a sectional view of an optical film for a backlight unit according to the present invention. Referring to the figure, the optical film 10 for a backlight unit of the present invention comprises a light diffusion layer 11 for diffusing light, a first refraction layer 13 for refracting the light diffused in the light diffusion layer 11 in a direction perpendicular to a surface of the film with a predetermined index of refraction, and a second refraction layer 15 which has a relatively high index of refraction compared to the first refraction layer 13 and collects and refracts the light passed through the first refraction layer 13 in the direction perpendicular to the surface of the film.

The light diffusion layer 11 is manufactured in the form of a soft sheet made of a transparent polyester-based resin, and light diffusing particles 11a for diffusing the light are distributed in the light diffusion layer. This light diffusing particles 11 are either transparent particles made of a material selected from the group consisting of acryl, styrene, silicone, synthetic silica, glass beads and diamond, or white particles made of a material selected from the group consisting of titanium oxide, zinc oxide, barium sulfate, calcium carbonate, magnesium carbonate, aluminum hydroxide, and clay.

The first refraction layer 13.is formed by coating a liquid acrylic resin on a top surface of the light diffusion layer 11. At this time, the first refraction layer 13 has a relatively low index of refraction and causes the light diffused in the light diffusion layer 11 to be primarily refracted in the direction perpendicular to the surface of a film sheet of the light diffusion layer 11. An angle of refraction corresponds to the index of refraction, which in turn is determined by a composition ratio of the acrylic resin.

The second refraction layer 15 is formed by coating the acrylic resin on a top surface of the cured first refraction layer 13 and then forming and curing a refraction pattern 17 on the coated surface. At this time, the second refraction layer 15 has an index of refraction relatively higher than the first refraction layer 13 and collects and refracts the light passed through the first refraction layer 13 in the direction perpendicular to the surface of a film sheet of the second refraction layer 15.

Here, an angle of refraction of the light refracted in the second refraction layer 15 corresponds to the index of refraction thereof, which in turn is higher than that of the first refraction layer 13 by adjusting a composition ratio of acrylic resin used in the second refraction layer.

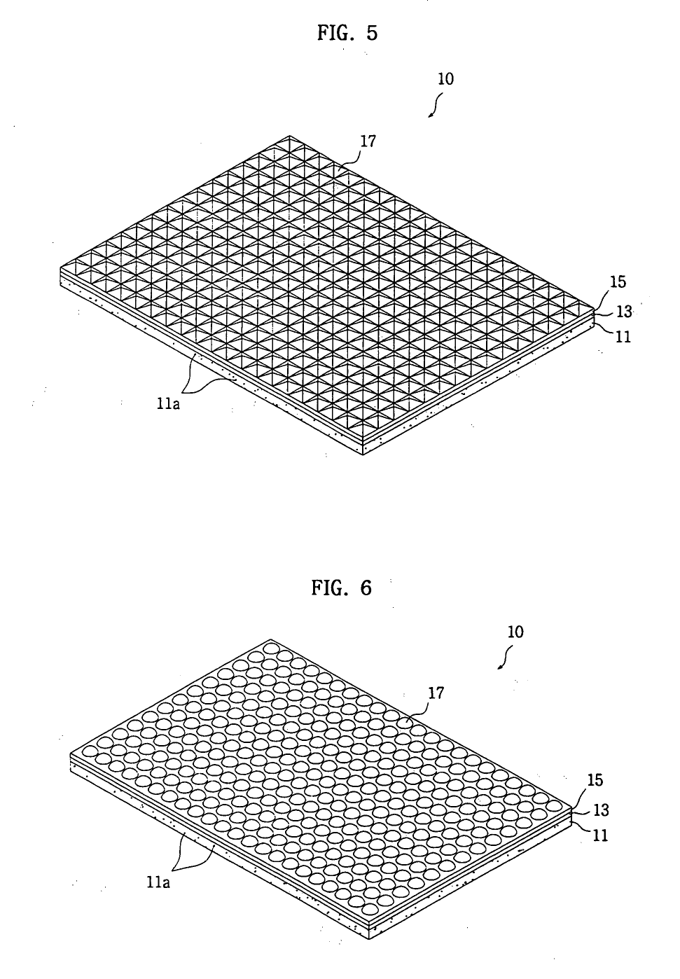

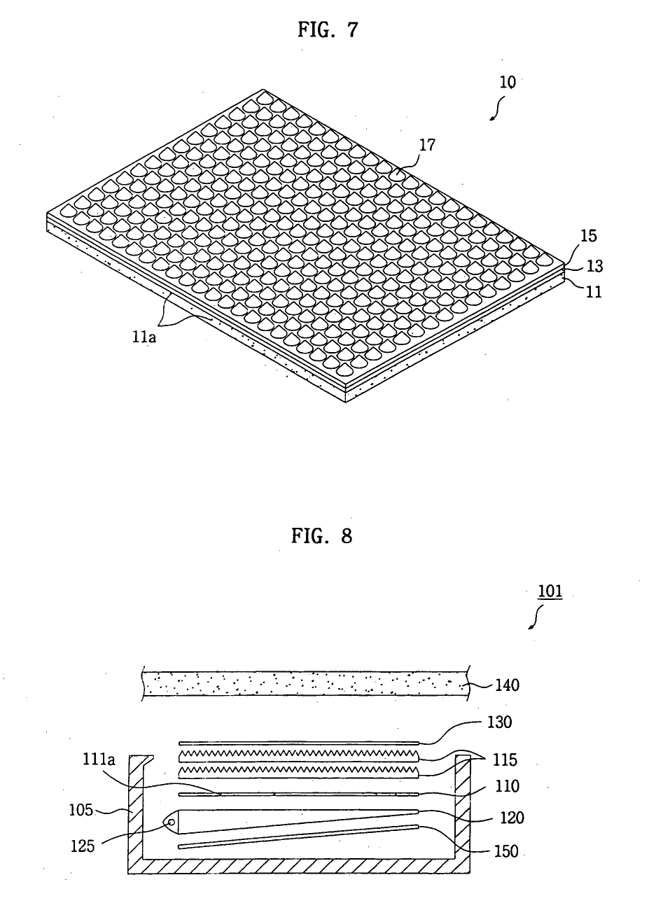

Further, as shown in FIG. 1, the refraction pattern 17 formed on the surface of the second refraction layer 15 may be formed to have a triangular cross section. Alternatively, as shown in FIGS. 4 to 7, the refraction pattern may be formed to have a shape selected from an arc cross section, a polygonal cone, a circular cone or a hemisphere. This refraction pattern 17 can be formed on the surface of the second refraction layer 15 by pressing with a roller mold or stamp mold having a pattern corresponding to the refraction pattern 17 before the second refraction layer is cured.

FIG. 2 is a block diagram illustrating the processes of manufacturing the optical film 10 for a backlight unit according to the present invention. As shown in the figure, the method for manufacturing the optical film 10 according to the present invention comprises a step S01 of forming the light diffusion layer 11 with the light diffusing particles 11a distributed therein, a step S02 of forming the first refraction layer 13 integrally on the top surface of the light diffusion layer 11, a step S03 of forming the second refraction layer 15 with the index of refraction relatively higher than that of the first refraction layer 13 on the top surface of first refraction layer, and a step S04 of forming the refraction pattern 17 on the surface of the second refraction layer 15.

The step S01 of forming the light diffusion layer 11 corresponds to a step of forming a transparent polyester resin containing the light diffusing particles 11a into a flexible sheet. As described above, the light diffusing particles 11a becomes either the transparent particles made of a material selected from acryl, styrene or the like, or the white particles made of a material selected from titanium oxide, zinc oxide or the like. Here, the light diffusion layer 11 may be obtained by cutting the existing transparent polyester sheet.

The step S02 of forming the first refraction layer 13 corresponds to a step of coating the liquid acrylic resin on the top surface of the light diffusion layer 11 and curing the coated resin. As described above, this first refraction layer 13 has a relatively low index of refraction by regulating the composition ratio of the acrylic resin.

The step S03 of forming the second refraction layer 15 is a step of coating the acrylic resin on the top surface of the cured second refraction layer 15. As described above, the second refraction layer 15 has an index of refraction relatively higher than that of the first refraction layer 13 by regulating the composition ratio of the acrylic resin.

The step S04 of forming the refraction pattern corresponds to a step of forming and curing the refraction pattern 17 by pressing the surface of the uncured second refraction layer 15 with a roller mold or stamp mold having a pattern corresponding to the refraction pattern 17. As described above, the refraction pattern 17 has a shape selected from a triangular cross section, a circular arc cross section, a polygonal cone, a circular cone or a hemisphere.

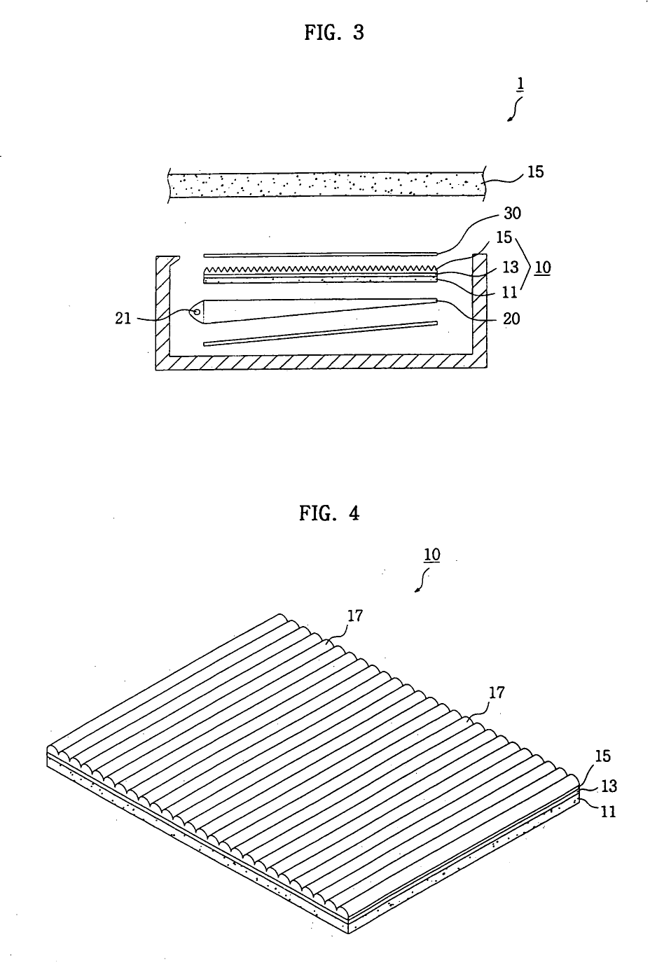

As shown in FIG. 3, the optical film 10 manufactured through the manufacturing processes according to the present invention is installed above the light guide plate 20 of the backlight unit 1. In such a state, when the light is transmitted to the optical film from the lamp 21 of the light guide plate 20, it is scattered and diffused in the light diffusion layer 11 and then is refracted at a predetermined angle of refraction in the first refraction layer 13. Then, the light is also collected and refracted in a direction almost perpendicular to the surface of the film in the second refraction layer 15 and enters into a panel 40 through a protection film 30.

The high brightness can be achieved without any loss of light, since the diffusion, collection and refraction of light are performed within the light diffusion layer and the first and second refraction layers formed in s single sheet of the optical film.

Further, the adsorption of foreign substances in and the scratch generation between the films occurring during the assembly process can be prevented since the light diffusion layer and the first and second refraction layers are formed in a single sheet of the optical film. In addition, the productivity improvement and manufacturing cost reduction can be made due to the decrease of the number of the assembly process.

Furthermore, since the indexes of refraction of the first and second refraction layers can be changed if necessary, the brightness of the backlight unit can be adjusted as required.

### INDUSTRIAL APPLICABILITY

According to the present invention, the loss of light can be prevented, the adsorption of foreign substances in and the resultant scratch generation on the films can be avoided during the assembly process of the backlight unit, the productivity improvement and manufacturing cost reduction can be achieved, and the brightness of the backlight unit can be adjusted.

Although the preferred embodiments of the present invention have been disclosed for illustrative purpose, it is apparent to those skilled in the art that various changes and modifications can be made thereto without departing from the scope and spirit of the present invention as defined by the claims.

1. An optical film for a backlight unit, comprising:
a light diffusion layer in which light diffusing particles are distributed;
a first refraction layer which has a relatively low index of refraction and is formed integrally on a top surface of the light diffusion layer; and
a second refraction layer which has an index of refraction relatively higher than that of the first refraction layer and is formed integrally on a top surface of the first refraction layer and formed with a refraction pattern on a surface thereof.

2. The optical film as claimed in claim 1, wherein the light diffusion layer is made of a transparent polyester resin, and the first and second refraction layers are made of a transparent acrylic resin.

3. The optical film as claimed in claim 2, wherein a difference between the indexes of refraction of the first and second refraction layers is determined by a difference between composition ratios of the transparent acrylic resins.

4. The optical film as claimed in claim 1, wherein the light diffusing particles are either transparent particles made of a material selected from the group consisting of acryl, styrene, silicone, synthetic silica, glass beads and diamond, or white particles made of at least one material selected from the group consisting of titanium oxide, zinc oxide, barium sulfate, calcium carbonate, magnesium carbonate, aluminum hydroxide and clay.

5. The optical film as claimed in claim 1, wherein the refraction pattern has a shape selected from the group consisting of a triangular cross section, a circular arc cross section, a polygonal cone, a circular cone or a hemisphere.

6. A method for manufacturing an optical film for a backlight unit, comprising the steps of:
forming a light diffusion layer with light diffusing particles distributed therein;
forming a first refraction layer with a relatively low index of refraction on a top surface of the light diffusion layer;
forming a second refraction layer with a relatively higher index of refraction on a top surface of the first refraction layer; and
forming a refraction patter on a surface of the second refraction layer.

7. The method as claimed in claim 6, wherein the light diffusing particles are made of a transparent polyester resin, and the first and second refraction layers are formed by coating a liquid transparent acrylic resin on the top surface of the light diffusion layer.

8. The method as claimed in 7, wherein a difference between the indexes of refraction of the first and second refraction layers is determined by a difference between composition ratios of the transparent acrylic resins.

9. The method as claimed in claim 6, wherein the light diffusing particles are either transparent particles made of a material selected from the group consisting of acryl, styrene, silicone, synthetic silica, glass beads and diamond, or white particles made of at least one material selected from the group consisting of titanium oxide, zinc oxide, barium sulfate, calcium carbonate, magnesium carbonate, aluminum hydroxide and clay.

10. The method as claimed in claim 6, wherein the step of forming the refraction pattern comprises the step of forming, on the surface of the second refraction layer, a shape selected from the group consisting of a triangular cross section, a circular arc cross section, a polygonal cone, a circular cone or a hemisphere.
